(19) United States
(12) Patent Application Publication
(10) Pub. No.: US 2003/0047895 A1
(43) Pub. Date: Mar. 13, 2003

(54) Mobile saw cart

(76) Inventor: Robert D. McElroy, Wellington, FL (US)

Correspondence Address: KING & SPALDING, 191 PEACHTREE STREET, N.E., ATLANTA, GA, 30303-1763, US

(21) Appl. No.: 10/238,299

(22) Filed: Sep. 9, 2002

Related U.S. Application Data
(60) Provisional application No. 60/317,708, filed on Sep. 7, 2001.

(51) Int. Cl. B62B 3/02

(52) U.S. Cl. 280/79.3

(57) ABSTRACT

The present invention provides a mobile cart on which a circular saw is mounted at a height comfortable for kneeling. The circular saw can be a miter saw, a compound saw, a slideable saw, or any combination thereof. The saw/cart combination is compact and low to the ground, and is particularly useful in the on-site installation of hardwood floors, finishing trim, and tile walls and flooring. The saw/cart combination preferably includes a channel and container for capturing sawdust generated by the saw. In addition, the saw is preferably DC-powered for ease of mobility.

### RELATED PATENT APPLICATIONS

This non-provisional patent application claims priority under 35 U.S.C. § 119 to U.S. Provisional Patent Application No. 60/317,708, titled Mobile Saw Cart for Indoor Use with Sawdust Capture, filed Sep. 7, 2001. Provisional Patent Application No. 60/317,708 is hereby incorporated herein by reference as if fully set forth herein.

### FIELD OF THE INVENTION

This invention relates to carts on which circular saws can be mounted and moved about a workspace, and to particular methods of using such carts in the installation of flooring surfaces. The circular saws are mounted onto the carts at a comfortable kneeling height in order to allow the worker to repeatedly cut flooring materials without standing while seated or kneeling.

### BACKGROUND OF THE INVENTION

Conventional power saws are typically either mounted onto a stationary bench or stand, or constructed as hand-held units that can be readily transported where needed at a work-site. Workers generally prefer to cut wood using stands because the stands improve the efficiency and accuracy of their cuts. However, stands onto which power saws are mounted generally are stationary units that are not meant to be moved. Some stands have wheels, but these stands tend to be large and heavy, and not meant to be continually moved during use. This lack of mobility is a problem because the stands must be established in fixed locations in workshops or at job-sites that often are not convenient to the site where cut pieces are being installed.

Besides lack of mobility, stand-mounted power saws of the prior art suffer from a number of other disadvantages. For example, conventional saws typically operate using 110 volts AC. However, some work sites, for example new home sites, often have limited AC power resources.

Furthermore, conventional power saws typically generate airborne sawdust, which can result in sawdust spreading throughout the interior of a structure in which the saw is employed. For example, working with a conventional power saw inside a home can result in sawdust covering the furnishings and floors and permeating into cupboards and closets. Also, airborne sawdust can present a health risk to workers breathing air containing the dust on a daily basis. Thus, workers who routinely use conventional power saws indoors typically must wear breathing protection, which reduces their productivity, communication capability, and overall comfort while working. While some conventional power saws include dust bags to capture the sawdust, these bags have limited capacity and must frequently be emptied during a workday.

When mounted to a stand, power saws have conventionally been mounted at workstation height, i.e., at a height off the ground greater than 36 inches, so that a worker can make cuts while standing. In some circumstances, however, such as when installing a flooring surface where the installer is seated or kneeling and must make multiple cuts, it would be desirable to have access to the saw while remaining in a seated or kneeling position.

Because of these limitations on using power saws, wood flooring installers generally leave the power saw outside when installing a wood floor. Wood flooring installers typically must make hundreds of saw cuts in a day, with each cut measured for a specific location on a floor. Thus, wood floor installers make hundreds of trips back and forth from the saw each day, wasting time. A saw located inside at a comforatble kneeling height could result in approximately 40 percent time savings. Additionally, wood floor installers work on their knees, so they must stand up each time they go outside to make a cut. This constant kneeling and standing is very physically demanding and can lead to health problems for those who install wood floors for a long period of time. Similar situations exist for interior wood trim installers, tile installers, or outdoor decking installers.

In view of the foregoing, there is a need for a mobile saw cart for indoor use that is specially designed to be lightweight, compact, operate on DC power, operate low to the floor, and to capture sawdust and other particles generated during the cutting process.

### SUMMARY OF THE INVENTION

The present invention can overcome the deficiencies of conventional stand-mounted power saws by providing a light-weight mobile cart with 360 degree mobility onto which a saw is mounted at a height close to the floor at no greater than a comfortable kneeling height. The saw is preferably a circular saw, and can be mounted to provide miter cuts, compound cuts, or sliding cuts, or any combination of the foregoing. The cart preferably incorporates a sawdust collection system to minimize airborne dust and debris. Moreover, the cart preferably accommodates a DC-powered saw.

Thus, in one embodiment the invention provides a mobile saw and cart comprising: (a) a base comprising an upper side and an under side; (b) a plurality of wheels attached to the underside of the base in a plane horizontal to the base, wherein each of the plurality of wheels rotates about a vertical axis to provide 360 degree angular movement of the cart; (c) a saw mounting frame attached to the upper side of the base; and (d) a power circular saw mounted to the saw mounting frame as a miter saw, a slideable saw, or a miter and slideable saw, at a height no greater than a comfortable kneeling height.

The invention further pertains to the cart onto which a saw is mounted. Thus, in another embodiment the invention provides a cart comprising (a) a base comprising an upper side and an under side; (b) a plurality of wheels attached to the underside of the base in a plane horizontal to the base, wherein each of the plurality of wheels rotates about a vertical axis to provide 360 degree angular movement of the cart; and (c) a saw mounting frame attached to the upper side of the base.

The cart/saw combination is particularly well adapted to work environments wherein the mobility of the saw, and the height at which it is mounted are critical considerations, such as in the installation of flooring surfaces. Flooring surfaces such as hard-wood floors, tile floors, and floor molding are well suited for installation using the cart/saw combination of the present invention. Thus, in another embodiment the invention provides a method of installing a floor surface comprising: (a) providing a mobile saw and cart comprising (i) a base comprising an upper side and an under side, (ii) a plurality of wheels attached to the underside of the base in a plane horizontal to the base, wherein each of the plurality of wheels rotates about a vertical axis to provide 360 degree angular movement of the cart, (iii) a saw mounting frame attached to the upper side of the base, and (iv) a power circular saw mounted to the saw mounting frame as a miter saw, a slideable saw, or a miter and slideable saw, at a height no greater than a comfortable kneeling height; (b) providing a plurality of flooring pieces; (c) cutting said plurality of flooring pieces into sized cut flooring pieces while sitting or kneeling in four or more cutting steps; and (d) installing said plurality of sized cut flooring pieces to yield a floor surface.

The aspects of the present invention may be more clearly understood and appreciated from a review of the following detailed description of the disclosed embodiments and by reference to the drawings and claims.

### BRIEF DESCRIPTION OF THE DRAWINGS

FIG. 1 is an exploded view of an exemplary embodiment of the present invention in which a commercially available compound miter saw is mounted to a mobile cart of the present invention.

FIG. 2 depicts a perspective assembly view of the exemplary embodiment illustrated in FIG. 1.

FIG. 3 presents an elevated perspective view of an alternative embodiment of the present invention with a miter sliding saw in its starting position.

FIG. 4 presents a second elevated perspective view of the alternative embodiment of the present invention shown in FIG. 3, with the miter sliding saw in its finishing position.

FIG. 5 presents a third elevated perspective view of the alternative embodiment of the present invention shown in FIG. 3, with the miter sliding saw in its starting position, from the back of the cart.

FIG. 6 depicts an isolated and exploded view of the miter guide and fence displayed in the alternative embodiment of the present invention presented in FIGS. 3-5.

### DETAILED DESCRIPTION OF THE EXEMPLARY EMBODIMENTS

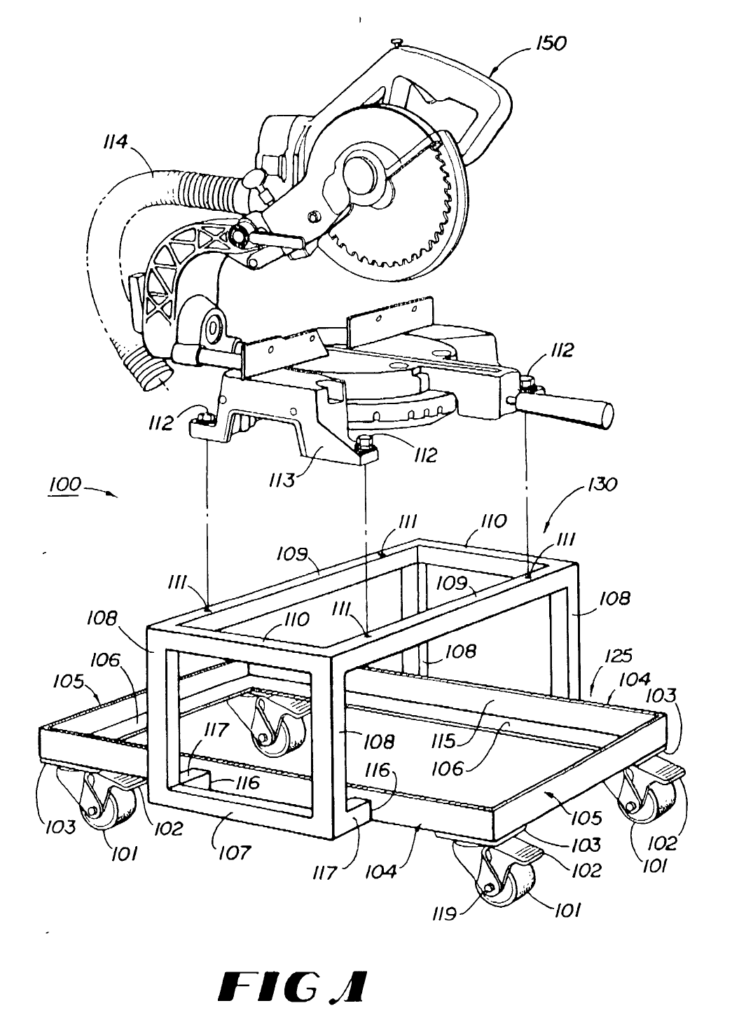

Exemplary embodiments of the present invention provide a mobile cart for mounting a power saw. FIG. 1 depicts an exemplary embodiment of the present invention. An exemplary mobile cart 100 has four casters 101, each caster 101 located at one of the four corners of a base 125 and having a brake mechanism 102 that prevents a caster from rotating about an axle 119 when engaged. Each caster 101 can be mounted to the base 125 with a mounting plate 103 and fasteners that may include nuts and bolts (not shown). Alternatively, the mounting plate 103 can be welded to the base 125. Each caster 101 can rotate about an axis perpendicular to the mounting plate 103 and the base 125 and positioned approximately in the center of the mounting plate 103. One skilled in the art would appreciate that a variety of wheels or casters can be used to enable the cart to freely roll, as for example, about the interior of a house during installation of a wood floor, and can prevent the cart from rolling when necessary. These wheels or casters can be connected to the base 125 in a variety of ways at a variety of locations on the base 125. The wheels generally must provide level support (thus at least three wheels must be employed), and that the wheels allow movement of the cart in all directions within a horizontal plane.

In an exemplary embodiment of the present invention, the base 125 is formed by two horizontal parallel members 104 attached orthogonally to the ends of two horizontal parallel members 105 to form a rectangular shaped base. In an exemplary embodiment of the present invention, the base 125 is 24 inches long and 16 inches wide. One skilled in the art would appreciate that the base could be a variety of shapes, for example round, oval, or square or any other polygon and a variety of sizes. In the exemplary embodiment in FIG. 1, each base members 104, 105 comprises two perpendicular pieces, one vertically-oriented 115 and one horizontally-oriented 106. The horizontal piece 106 extends from the vertical piece 115 inward towards the center of the base, forming a ledge that can support a container for sawdust (not shown). One skilled in the art will appreciate that a container can be supported with only two ledges, and in a variety of ways other then this ledge arrangement and that the base members 104, 105 could each comprise a single piece.

A saw mounting frame of the exemplary embodiment shown in FIG. 1 has two parallel vertical members 108 connected orthogonally to the ends of two parallel horizontal members, a lower member 107 and an upper member 110, to form a side of the mounting frame 130. A second side of the mounting frame 130 is also formed by two parallel vertical members 108 connected orthogonally to the ends of two parallel horizontal members, the lower member 107 and the upper member 110. Each vertical member 108 is connected to one of the horizontal parallel members 104 at points 116 by a horizontal member 117. In an alternative embodiment, the vertical members 108 could be attached directly to the base 125.

The vertical members 108 are preferably of a height that supports installation of a saw onto the unit at a height that is no greater than a comfortable kneeling height. Because it is generally most comfortable to operate a saw below shoulder level, a comfortable kneeling height refers to the shoulder height of an average human (between 5′6″ and 6′ in height) in kneeling position. Thus, the saw is preferably mounted such that the initial mid-line grasp of the saw occurs at a point that is less than about 44 inches, 40 inches, 36 inches, 32 inches, 28 inches, 24 inches, or 20 inches off the ground. To support a comfortable kneeling height, the vertical members 108 preferably range in height from six inches to thirty-six inches and preferably have a height equal to or less than twenty inches. In an alternative embodiment, the vertical members 108 can comprise telescoping mounts so that the saw mounting frame 130 can be adjusted to different heights.

Two upper horizontal parallel members 109 are connected orthogonally to the upper members 110 and in the same horizontal plane as upper member 110 to form a saw mounting plane. The two upper horizontal parallel members 109 are also connected orthogonally to the top ends of the vertical members 108. The upper horizontal member 109 can have pre-drilled holes 111 to facilitate attaching a commercially-available power saw 150, such as a slide compound miter saw. Screws 112 or similar fasteners are used to attach a base 113 of power saw 150 to the upper horizontal member 109.

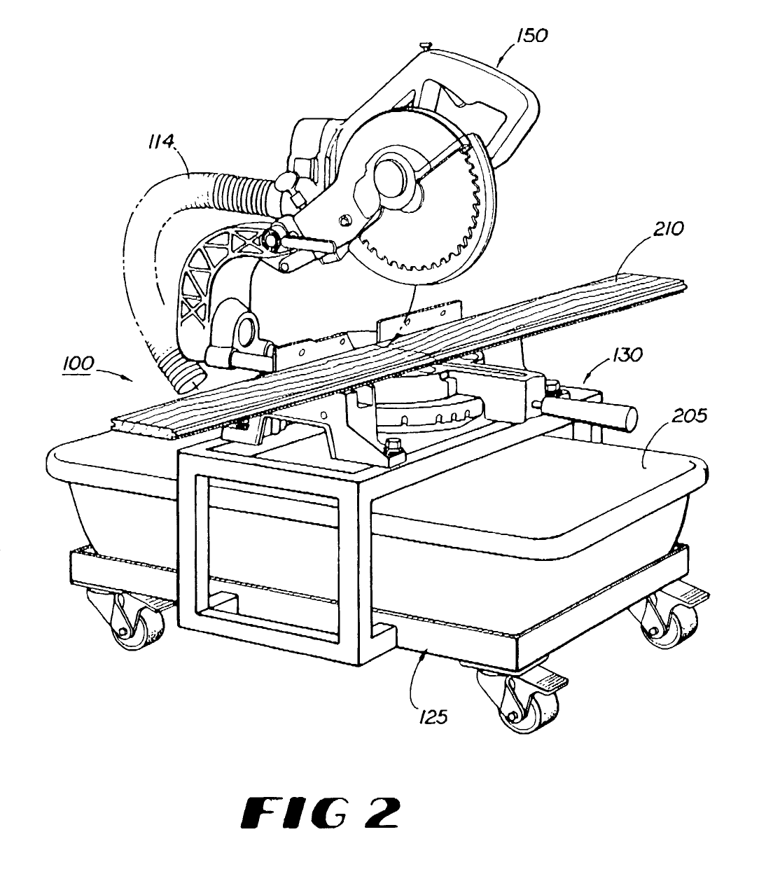

A hose 114 captures sawdust generated during a cut and carries the sawdust and other particles to a container (not shown) supported by the base 125. Turning now to FIG. 2, a perspective assembly view of an exemplary embodiment of the present invention is shown. In particular, the mobile cart 100 with the power saw 150 attached to saw mounting frame 130 is shown. The base 125 supports a container 205. The hose 114 carries sawdust to the container 205. One skilled in the art will appreciate that a variety of containers could be used to hold sawdust carried from the saw 150 through the hose 114 to the container 205 while cutting wood stock 210.

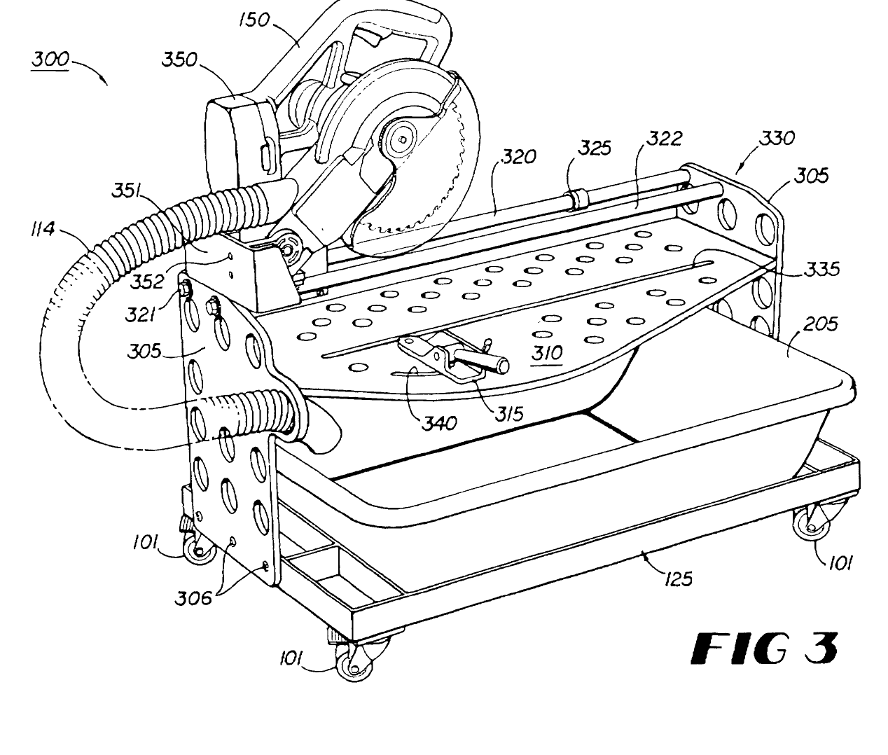

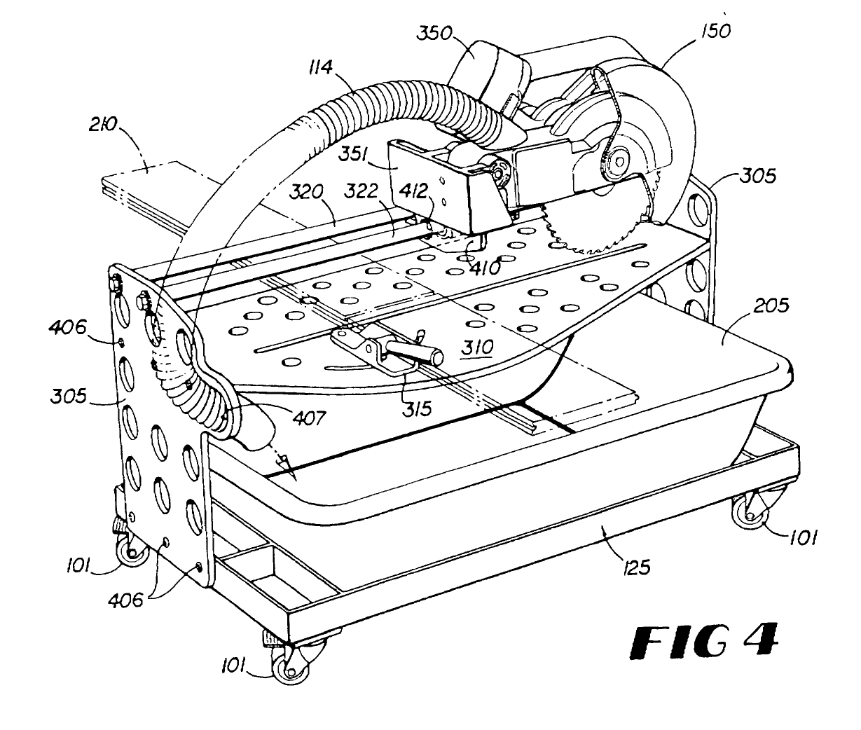

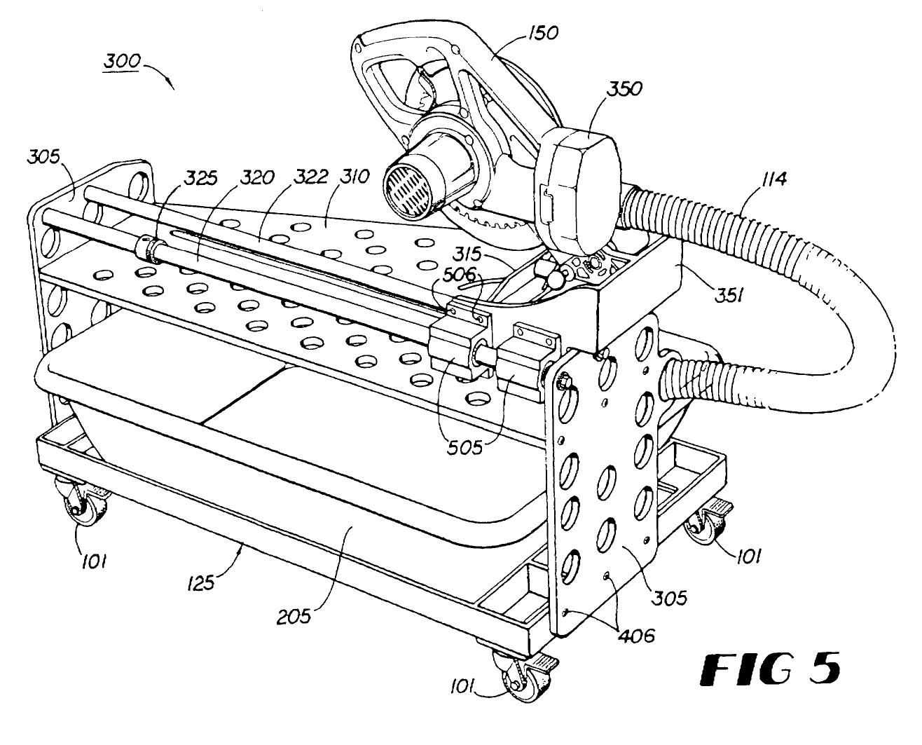

FIGS. 3, 4, and 5 depict an alternative embodiment of the present invention. Turning to FIGS. 3-5, the alternative embodiment of a mobile cart 300 comprises a saw mounting frame 330. A saw mounting frame 330 comprises two parallel vertical members 305 and a horizontal platform 310. Each vertical member 305 is connected to the base 125 using one or more screws 306 or similar fasteners. The vertical members 305 can be made out of a variety of materials and can have holes cut through its surface to reduce weight. The vertical members 305 preferably support a saw at no greater than a comfortable kneeling height, and thus typically range in height from six inches to thirty-six inches and preferably have a height equal to or less than twenty inches.

The horizontal platform 310 is orthogonally attached to each vertical member 305 with one or more screws 406. The horizontal platform 310 can be made from a variety of materials and can have holes through the surface to reduce weight. In an alternative embodiment, the vertical members 305 can have holes for screws 406 at different heights off the ground to allow the horizontal platform 310 to be adjusted to different heights.

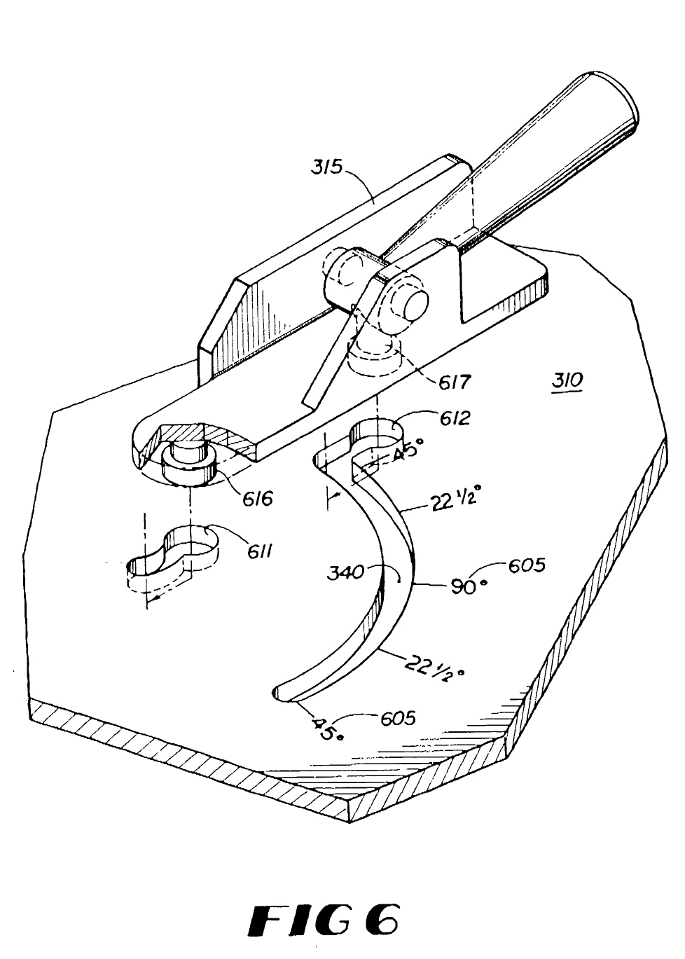

The horizontal platform 310 can include a miter fence 315 that can move along a slot 340 to form miter cutting angles (see FIG. 6 and accompanying discussion for more detail). The width of the horizontal platform is not critical to the invention, but can generally be optimized for comfort and ease of use during operation. Thus in preferred embodiments, the platform is less than 48, 44, 40, 36, 32, or 28 inches at its point of greatest width. At its point of smallest width, the platform is preferably less than 32, 28, 24, 20, or 16 inches in width. In a preferred embodiment the platform comprises more than one width, and its point of greatest width is substantially directly beneath the saw when the saw initially engages a piece of wood, to facilitate cuts of longer pieces of wood.

The power saw 150 is mounted on a saw mounting structure 351 using one or more screws or similar fasteners 352. The saw mounting structure 351 is attached to a horizontal rod 320 by sliding brackets 505. These brackets are attached to saw mounting structure 351 with one or more screws 506 or similar fasteners. A vertical plate 410 is attached orthogonally to the horizontal bottom of saw mounting structure 351. The vertical plate 410 can have an opening 412 that allows the horizontal rod 322 to pass through it. This assembly allows the saw mounting structure 351 to move horizontally along the horizontal rods 320 and 322 when the saw is engaged in a cutting operation. A stop 325 prevents the power saw 150 from hitting the vertical member 305 when the saw mounting structure 351 is moved along the horizontal rods 320, 322.

The horizontal rods 320, 322 are connected at either end to each vertical member 305. Bolts and lock washer 321 or similar fastener can be used to connect the horizontal rods 320, 322 to vertical members 305. The horizontal rods 320, 322 may have ends with predrilled holes and threading to facilitate using bolts and lock washers 321.

The power saw 150 can be powered by a DC power source 350 connected to the power saw 150. The hose 114 can be connected to the vertical member 305 by insertion through aperture 407 or similar fastener.

FIG. 6 depicts an isolated exploded view of the rotating miter fence 315 incorporated into the horizontal platform 310 shown in the alternative embodiment depicted in FIGS. 3-5. The miter fence 315 may connect to the horizontal platform 310 with slots 611, 612 cut into horizontal platform 310 and keys 616 and 617 attached to the miter fence 315. The key-and-slot configuration allows the miter fence 315 to pivot on key 616 in slot 611 so that the miter fence 315 can move along slot 340 in a plane parallel to the horizontal platform 310. The horizontal platform 310 may have one or more indicators such as an indicator 605 to indicate a position along the slot 340 corresponding to a specific cut angle by the power saw.

Overall, the mobile cart is preferably compact and lightweight. The cart is preferably less than 72 inches, 66 inches, 60 inches, 54 inches, or 48 inches in length (at its greatest point of length), and less than 44, 40, 36, or 32 inches in width (at its greatest point of width). Preferred length and width are generally independent of one another. The cart and saw combination is preferably less than 80 pounds, 70 pounds, 60 pounds, 50 pounds, 40 or 30 pounds in weight.

The saw employed in the invention can be a compound miter saw as illustrated in FIGS. 1 and 2, a slideable miter saw as illustrated in FIGS. 3, 4, and 5, or any combination of these types of saws (i.e. compound, miter, and/or slideable). As shown in the figures, the saw is preferably a circular power saw.

In an alternative embodiment of the present invention, the cart can comprise molded composite materials with a removable saw mounting platform for ease in manufacturing. A base of the alternative embodiment comprises a molded sawdust container and caster mounts for push-in type casters. The saw mounting platform can be attached to the base by screws through aligned, pre-drilled holes in both the base and the saw mounting platform. In the alternative embodiment of the present invention, the height of the saw mounting platform and sawdust container combination can be less then 12 inches and the length less than 32 inches and the width less the 24 inches.

The mobile cart and sawdust container of any embodiment of the present invention can be manufactured from a variety of materials, including plastic, metal, fiberglass, or any other suitable material. The preferred embodiments of the present invention would be manufactured from lightweight components. In an alternative embodiment, the saw mounting frame and sawdust container can be molded as a single plastic unit and casters or wheels attached thereto. Also, alternative embodiments can include features that make cutting wood stock easier, such as mechanisms that hold the stock in place during cutting.

What is claimed is:

1. A mobile saw and cart comprising:
a base comprising an upper side and an under side;
a plurality of wheels attached to the underside of the base in a plane horizontal to the base, wherein each of the plurality of wheels rotates about a vertical axis to provide 360 degree angular movement of the cart;
a saw mounting frame attached to the upper side of the base; and
a power circular saw mounted to the saw mounting frame as a miter saw, a slideable saw, or a miter and slideable saw, at a height no greater than a comfortable kneeling height.

2. The mobile saw and cart of claim 1 further comprising:
a sawdust container; and
a hose configured and positioned to capture sawdust.

3. The mobile saw and cart of claim 1 wherein said comfortable kneeling height is less than 36 inches.

4. The mobile saw and cart of claim 1 wherein said comfortable kneeling height is less than 30 inches.

5. The mobile saw and cart of claim 1 of an aggregate weight of less than about 80 pounds.

6. The mobile saw and cart of claim 1 of an aggregate weight of less than about 60 pounds.

7. The mobile saw and cart of claim 1 wherein comprising a maximum length and a maximum width, wherein the maximum length is less than about 48 inches and the maximum width is less than about 36 inches.

8. The mobile saw and cart of claim 1 wherein the saw is powered by DC power.

9. The mobile saw and cart of claim 1 wherein the saw is a compound miter saw.

10. The mobile saw and cart of claim 1 wherein the saw is a slideable miter saw.

11. The mobile saw and cart of claim 1 wherein the base comprises a first pair of horizontal members attached orthogonally to a second pair of horizontal members in the form of a rectangle.

12. The mobile saw and cart of claim 11 wherein each member of the first pair of horizontal members comprises a ledge extending transversely within the rectangle, further comprising a bin resting on the ledges for containing sawdust.

13. The mobile saw and cart of claim 1 wherein the saw mounting frame comprises a cutting platform horizontal to said base.

14. The mobile saw of claim 13 wherein the cutting platform has a maximum width of less than 48 inches and greater than 20 inches.

15. The mobile saw and cart of claim 13 wherein the cutting platform comprises a miter fence, the miter fence comprising:
a plurality of keys attached to miter fence, the keys fitting into a plurality of slots that enable the miter fence to pivot on a key so that miter fence can move along an arced slot in a plane parallel to horizontal platform to form miter angles for the saw cuts.

16. The mobile saw and cart of claim 15, wherein the horizontal platform has indicators marked along the arced slot that indicate the cut angle.

17. The mobile saw and cart of claim 1 wherein the saw mounting frame comprises:
a first vertical member between six inches and thirty-six inches in length attached orthogonally to the upper side of the base;
a second vertical member between six inches and thirty-six inches in length attached orthogonally to the upper side of the base parallel to the first vertical member;
a horizontal platform extending between and attached orthogonally to the vertical members; and
a first horizontal rod and second horizontal rod attached orthogonally to the vertical members at a position above the horizontal platform, the first horizontal rod attached to the vertical member parallel to and at the same height as the second horizontal rod;
wherein the circular saw is mounted on the horizontal rods for sliding along the horizontal rods.

18. The mobile saw and cart of claim 1 wherein the saw mounting frame comprises:
first, second, third and fourth vertical members between six inches and thirty-six inches in length comprising upper and lower ends, wherein the lower ends of the vertical members are attached to the upper side of the base to the base, and the first and second vertical members are opposed to the third and fourth vertical members; and
first and second horizontal member attached orthogonally to the upper ends of the first and third vertical members, and second and fourth vertical members, respectively;
wherein the power saw is mounted on the upper horizontal members.

19. A method of installing a floor surface comprising:
providing a mobile saw and cart comprising:
a base comprising an upper side and an under side;
a plurality of wheels attached to the underside of the base in a plane horizontal to the base, wherein each of the plurality of wheels rotates about a vertical axis to provide 360 degree angular movement of the cart;
a saw mounting frame attached to the upper side of the base; and
a power circular saw mounted to the saw mounting frame as a miter saw, a slideable saw, or a miter and slideable saw, at a height no greater than a comfortable kneeling height;
providing a plurality of flooring pieces;
cutting said plurality of flooring pieces into sized cut flooring pieces while sitting or kneeling in four or more cutting steps; and
installing said plurality of sized cut flooring pieces to yield a floor surface.

20. The method of claim 19 further comprising moving the mobile saw and cart in three or more directions within a horizontal plane between said four or more cutting steps.

21. The method of claim 19 wherein said floor surface comprises a tile floor.

22. The method of claim 19 wherein said floor surface comprises a wooden floor.

23. The method of claim 19 wherein said floor surface comprises floor molding.

24. A mobile cart for mounting a saw comprising:
a base comprising an upper side and an under side;
a plurality of wheels attached to the underside of the base in a plane horizontal to the base, wherein each of the plurality of wheels rotates about a vertical axis to provide 360 degree angular movement of the cart; and
a saw mounting frame attached to the upper side of the base.

25. The mobile cart of claim 24 further comprising:
a sawdust container; and
a hose configured and positioned to capture sawdust.

26. The mobile cart of claim 24 wherein said comfortable kneeling height is less than 36 inches.

27. The mobile cart of claim 24 wherein said comfortable kneeling height is less than 30 inches.

28. The mobile cart of claim 24 of an aggregate weight of less than about 80 pounds.

29. The mobile cart of claim 24 of an aggregate weight of less than about 60 pounds.

30. The mobile cart of claim 24 comprising a maximum length and a maximum width, wherein the maximum length is less than about 48 inches and the maximum width is less than about 36 inches.

31. The mobile cart of claim 24 wherein the base comprises a first pair of horizontal members attached orthogonally to a second pair of horizontal members in the form of a rectangle.

32. The mobile cart of claim 31 wherein each member of the first pair of horizontal members comprises a ledge extending transversely within the rectangle, further comprising a bin resting on the ledges for containing sawdust.

33. The mobile cart of claim 24 wherein the saw mounting frame comprises a cutting platform horizontal to said base.

34. The mobile saw of claim 33 wherein the cutting platform has a maximum width of less than 48 inches and greater than 20 inches.

35. The mobile cart of claim 33 wherein the cutting platform comprises a miter fence, the miter fence comprising:
a plurality of keys attached to miter fence, the keys fitting into a plurality of slots that enable the miter fence to pivot on a key so that miter fence can move along an arced slot in a plane parallel to horizontal platform to form miter angles for the saw cuts.

36. The mobile cart of claim 35, wherein the horizontal platform has indicators marked along the arced slot that indicate the cut angle.

37. The mobile cart of claim 24 wherein the saw mounting frame comprises:
a first vertical member between six inches and thirty-six inches in length attached orthogonally to the upper side of the base;
a second vertical member between six inches and thirty-six inches in length attached orthogonally to the upper side of the base parallel to the first vertical member;
a horizontal platform extending between and attached orthogonally to the vertical members; and
a first horizontal rod and second horizontal rod attached orthogonally to the vertical members at a position above the horizontal platform, the first horizontal rod attached to the vertical member parallel to and at the same height as the second horizontal rod;
wherein the circular saw is mounted on the horizontal rods for sliding along the horizontal rods.

38. The mobile cart of claim 24 wherein the saw mounting frame comprises:
first, second, third and fourth vertical members between six inches and thirty-six inches in length comprising upper and lower ends, wherein the lower ends of the vertical members are attached to the upper side of the base to the base, and the first and second vertical members are opposed to the third and fourth vertical members; and
first and second horizontal member attached orthogonally to the upper ends of the first and third vertical members, and second and fourth vertical members, respectively;
wherein the power saw is mounted on the upper horizontal members.

39. The mobile cart of claim 24 wherein the base comprises a molded sawdust container and caster mounts and push-in casters; and
wherein the saw mounting frame is a platform that attaches to the top of the base.
